(19) United States
(12) Patent Application Publication
(10) Pub. No.: US 2003/0059200 A1
(43) Pub. Date: Mar. 27, 2003

(54) Recording and re-insertion of teletext data

(75) Inventors: Maurice Cuijpers, San Jose, CA (US); Jan Van Ee, Cupertino, CA (US)

Correspondence Address: Corporate Patent Counsel, Philips Electronics North America Corporation, 580 White Plains Road, Tarrytown, NY, 10591, US

(73) Assignee: KONINKLIJKE PHILIPS ELECTRONICS N.V.

(21) Appl. No.: 09/963,260

(22) Filed: Sep. 25, 2001

(51) Int. Cl. H04N 11/00; H04N 5/76; H04N 5/781

(52) U.S. Cl. 386/46; 348/465; 348/468; 386/125

(57) ABSTRACT

A digital recording system comprising a digital processor and a memory. The digital processor selects related data packages from a datastream, wherein said related data packages are interleaved with other data packages in the datastream in a repeating cycle. The digital processor stores the selected related data packages in a file in a memory. The same or another processor may creates a playback datastream of the recorded related data packages by retrieving the initially recorded data packages for the recorded related data packages for output in the playback datastream. The processor retrieves and substitutes subsequently recorded related data packages in the playback datastream at the appropriate point to create the playback datastream.

### BACKGROUND OF THE INVENTION

1. Field of the Invention

The invention relates to the recording of Teletext data and playing back stored Teletext data.

2. Description of the Related Art

Teletext data is comprised of textual data that is transmitted as part of a television signal. Teletext data is typically transmitted according to existing standards. Teletext data is more prominently used in countries other than the United States, for example, numerous European countries. However, Teletext standards have also been adopted in the U.S.

Teletext data standards accommodate subtitle pages relating to the video being broadcast by a particular channel. The appearance of such subtitle Teletext data is similar to closed captioning in the United States. Subtitle Teletext data appears on the bottom lines of a television or other display screen concurrently with the video broadcast.

Teletext standards also include textual pages that may be viewed in their entirety. In those locations where it is in use, numerous textual pages relating to various subjects are generated and sent with the broadcast stream. Teletext pages may be generated for news, sports, arts, etc. Within such broad topics, more specific Teletext pages may be generated, such as Teletext pages for soccer, baseball, football, etc. for sports.

Teletext pages may be generated in real time, for example, by typists entering data as it happens at a site that interfaces with the transmission site. Alternatively, they may be periodically updated.

Teletext pages may number in the hundreds. According to a known standard, Teletext page numbers range from 100 to 8FF. For a user that can only select Teletext pages using numerals, this range is equivalent to 100 to 899. (Hereinafter, Teletext pages will be referred to by whole numbers, for convenience.) Teletext pages are linked and accessible by number. For example, page number 200 may refer to news, 300 to sports, 400 to arts, etc. For sports, page 305 may refer to soccer, 310 to baseball, 315 to football, etc. Thus, a viewer watching a television in a region that supports Teletext will typically have a “Teletext” button on the remote or television, which, when depressed, accesses on-screen menu navigation of the various pages. When the user navigates the menu to page 310 in the above example, the Teletext page(s) for baseball appear on the screen. The baseball Teletext page may give, for example, current scores, final scores, standings, breaking news, etc. There may also be sub-pages, for example, 310/1 (page 310, sub-page 1) may refer to final baseball scores.

As will be described in further detail below, each line of the Teletext page is separately formatted and transmitted; thus the unit of transmission of a Teletext page is actually a line. The lines of a subtitle Teletext page include an identifying “subtitle control bit” set to 1 in the page header data for the line. When subtitles are accessed by a user using the pertinent page number of the Teletext menu, the lines for the subtitle pages, corresponding to the video broadcast of the channel being viewed, appear at the bottom portion of the video broadcast. Because the content of the subtitle pages are related to the video content, it is important that the timing of the pages (and lines of pages) of the subtitle pages are correlated to the video content for reproduction.

As per the various standards pertaining to format and transmission of Teletext data, Teletext data is transmitted during the portion of the broadcast video signal corresponding to the vertical blanking period, color burst, etc. of the display. The pages of Teletext data are “pushed” or transmitted through the broadcast signal on a cyclical basis, which can take on the order of a hundred pages per every few seconds. For example, basic Teletext broadcast using the PAL (Phase Alternation Line) color modulation standard common in Europe transmits at a rate on the order of 25 pages/sec. As noted, depending on the topic of the page or pages, and the resources of the provider of those pages, pages (or, as noted, certain lines of pages constituting the unit of transmission of a page) may be frequently or periodically updated. However, considering the frequent cycling of the entire set of Teletext pages, many pages (and lines of pages) in the set will be re-broadcast a number of times without any change to the content.

Certain issues relating to recording Teletext data have been addressed in the prior art. While the rate at which Teletext data is processed for display is on the order of 100 Kbps, owing to various formatting protocols, Teletext data is transmitted at a frequency bandwidth on the order of 5.5 Mhz. This is more than can be recorded on an analog video recorder (such as a VHS VCR), which has a bandwidth on the order of 3 Mhz. One solution to this proposed in the prior art has been to convert Teletext data into a multilevel code at a lower data rate, such as a quarternary code at half the data rate. The lower data rate (such as 2.25 Mhz for a quarternary code) permits recording by the analog VCR. Such methods and systems are described, for example, in European Patent Application EP 0797354 A1 and PCT Application WO 99/12335, the contents of which are both hereby incorporated by reference.

Recording Teletext data on certain digital tape recording systems has also been proposed. Such digital recording systems generally do not have the recording bandwidth limitations of an analog video recorder. Thus, conceptually, there are no barriers to recording Teletext data directly in a digital recording device or system, without the use of multilevel codes as discussed above, or other fundamental restructuring. Examples of digital tape recording systems that purportedly record the entire Teletext datastream are described in European Patent Application 0610864 A2 (the '864 patent) entitled “A digital recording apparatus including teletext signals without decoding” by Melzer (filed Feb. 7, 1994) and European Patent Application 0624876 A2 (the '876 patent) entitled “Recording and reproduction of digital video and audio data” by Kimura, et al. (filed May 6, 1994). The contents of both the '864 and '876 patent are hereby incorporated by reference herein.

As noted, the two systems described in the '864 and '876 patents purport to be digital video tape recorders, which have failed commercially. In addition, the systems purport to record all Teletext data included in the video stream. As noted above, while this may be technically feasible in a digital video recorder, it is highly inefficient. As described in detail above, the Teletext datastream can include hundreds of pages of textual data, most of which will be of no interest to a user. Thus, recording all of the Teletext data in the datastream is a grossly inefficient use of recording system's resources. Moreover, as also noted above, many of the pages (as reflected in the lines of the pages transmitted) of the Teletext datastream changes slowly over time. Recording the unchanged lines of an incoming Teletext page in a subsequent transmission cycle of the Teletext data is also unnecessary and an inefficient use of recording resources.

### SUMMARY OF THE INVENTION

Accordingly, it is an objective of the invention to provide a digital video recording system that records Teletext and other data for playback in a manner that is fast and efficient, thus preserving system resources for other applications, space reduction, etc.

More generally, the invention comprises a digital recording system comprising a digital processor and a memory. The digital processor selects related data packages from a datastream, wherein said related data packages are also interleaved with other data packages in the datastream in a repeating cycle. The digital processor stores the selected related data packages in a file in a memory.

In one particular embodiment, the data packages in the datastream make up one or more Teletext pages. Thus, the processor selects and records related data packages of lines that make up at least one of the Teletext pages included in the datastream. The processor may select and record all related data packages for the at least one Teletext page included in all of the received cycles of the Teletext datastream. Alternatively, the processor may select and record related data packages included in the datastream when they differ from the content of data packages last selected and recorded by the processor for the same Teletext page. The data packages may be, for example, the lines that make up the selected Teletext page. The data package may alternatively be the selected Teletext page in its entirety.

The same or another processor may create a playback datastream of the recorded related data packages by retrieving the initially recorded data packages for the recorded related data packages for output in the playback datastream. The initially recorded related data packages create a carousel of data that is cyclically used as the playback datastream. The processor retrieves and substitutes subsequently recorded related data packages in the carousel at the appropriate time so that the content of the playback datastream corresponds to the original datastream. The recorded related data packages may be recorded with an indicia of time received in the original datastream. The indicia of time is usable to create a playback datastream of the related data packages.

Where, for example, the recorded related data packages are lines that make up at least one Teletext page, the playback datastream of the at least one Teletext page is created by retrieving the initially recorded lines for the at least one Teletext page corresponding to the first cycle of Teletext data received and recorded from the original datastream. The initial Teletext page is output in the playback datastream and used to create a carousel of data that is repeated for the playback datastream. Subsequently recorded lines of the at least one Teletext page that have changed in content (which correspond to subsequent cycles in the original datastream) are substituted in the carousel that make up the playback datastream based on the indicia of time recorded with the Teletext page.

The invention also comprises a method of digital recording comprising the steps of selecting related data packages from a datastream, wherein said related data packages are interleaved with other data packages in the datastream in a repeating cycle, and storing the selected related data packages. For example, the data packages selected and stored may be lines that make up a particular page (or pages) of Teletext data and, in particular, those lines in the current cycle that have changed from the last line stored in memory for the page.

The invention also comprises a method of creating a digital playback datastream of recorded related data packages by retrieving the initially recorded data packages for the recorded related data packages and outputting them in the playback datastream. Subsequently recorded related data packages are retrieved and substituted in the playback datastream at the appropriate time as in the originally recorded datastream. For example, where the recorded data packages are lines that make up a particular page (or pages) of Teletext data, the lines that make up the initial page received and recorded in the original datastream are retrieved and output. The initial lines are output in a repeating cyclical fashion to create the playback datastream. Lines recorded from subsequent cycles that represent changes of the lines of the page last retrieved and output are retrieved at the appropriate time and substituted for the lines in the particular page of Teletext data being cyclically output in the playback datastream.

### BRIEF DESCRIPTION OF THE DRAWINGS

FIG. 1 illustrates components of digital video recording and playback system in accordance with the invention;

FIGS. 2a and 2b are flowcharts depicting processing conducted by the processing component of FIG. 1 in accordance with the invention;

FIGS. 3a and 3b are flowcharts depicting processing conducted by the processing component of FIG. 1 in accordance with another embodiment of the invention; and

FIG. 3c represents a data structure created by the processing of FIGS. 3a and 3b.

### DETAILED DESCRIPTION

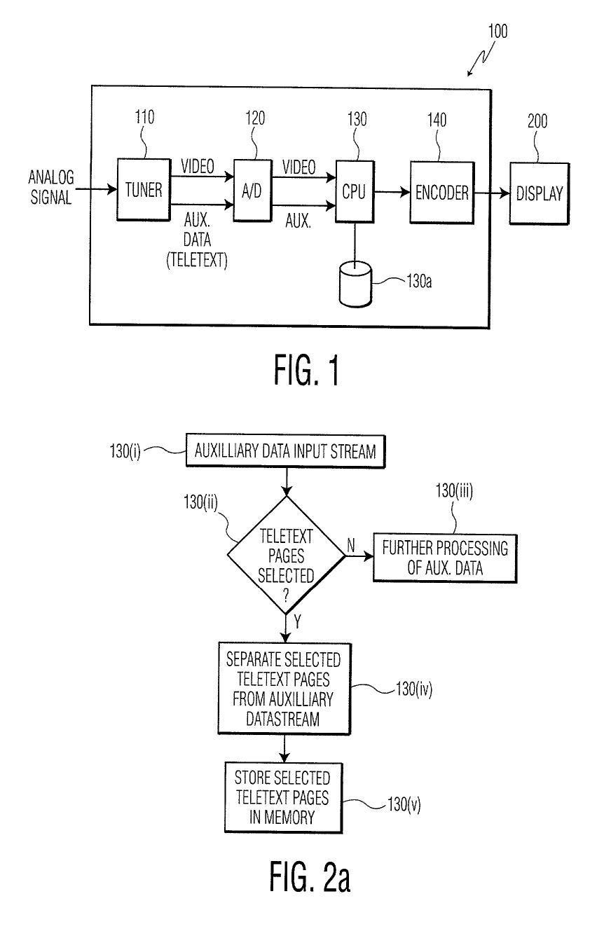

FIG. 1 comprises a digital video recording and playback system 100 in accordance with the present invention. An analog broadcast signal is input to tuner 110. The term “broadcast” may refer to cable, satellite, internet and other analog transmissions, as well as traditional over-the-air transmissions. As noted above, the analog signal may contain video for a number of channels as well as “auxiliary data”, such as pages of Teletext data. As known in the art and included in broadcast standards, such auxiliary data is transmitted in well-defined segments of the signal. The analog signal also typically contains control signals, such as vertical sync signals, blanking signals, etc. used as control signals by a standard television.

Tuner 110 strips the control signals from the analog signal and separates the video and auxiliary data portions of the analog signal, which are then input to A/D converter 120. A/D converter outputs a corresponding digital video datastream and a digital auxiliary datastream to CPU 130.

CPU 130 processes the video and auxiliary datastreams based on a selection input by a user, for example. Such selection input is not shown in FIG. 1, but generally relates to the user's recording selection, made via a remote and an on-screen menu. The user's recording selection may include, for example, a video program included in the video portion and/or the non-video data (such as Teletext data) included in the auxiliary data portion. The CPU 130 selects those portions of the video and/or auxiliary data portions based on the input and discards the rest of the video and auxiliary potions. For example, if the input programs the video recorder 100 to record a program broadcast on a particular channel, the CPU selects the datastream for that particular channel from the appropriate segments for the format of the received video signal (as pre-processed by tuner 110 and A/D converter 120), and discards the data for the other channels. Particular processing used by the CPU 130 in the selection and discarding of Teletext data from the auxiliary data portion will be described further below.

The CPU 130 compresses the selected video and/or auxiliary data and stores the compressed data on a digital memory, such as disk drive 130a.

When playing back the recorded video program or auxiliary data, the CPU 130 receives input from the user, also not shown in FIG. 1. The CPU 130 may, for example, display the recorded shows, etc. stored in the memory 130a on the display 200 and the user may select the item to be played back through a menu. The CPU 130 retrieves the datastream of the program or auxiliary data item from memory, decompresses it, and outputs it to encoder 140. Encoder 140 reformats the video and/or data content such that it is compatible with the user's display 200. This may include, for example, a D/A conversion as well as providing control signals to the video and/or datastream. The output of the encoder is received by display 200, which displays the video program and/or the auxiliary data items (such as Teletext data) selected for playback.

The various components comprising system 100 have been separately depicted in FIG. 1, which may represent, for example, separate chips. It is understood that particular components of FIG. 1 may be combined or separated. For example, tuner 110 and A/D converter 120 may be consolidated in one chip, or may be combined in CPU 130. On the other hand, the compression and decompression processing of CPU 130, for example, may be carried out by one or more separate chips or modules.

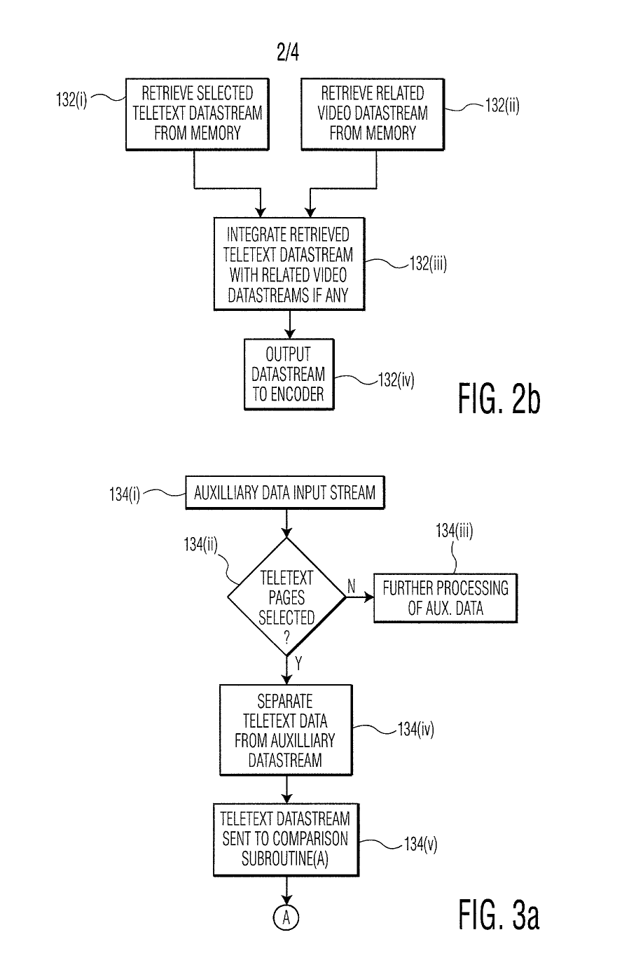

FIG. 2a is a flowchart depicting processing conducted by the CPU 130 of FIG. 1 in accordance with one aspect of the invention. Focusing on the digitized auxiliary datastream output by the A/D converter 120, the auxiliary datastream is input to CPU 130 (step 130(i)). If the system has not been programmed (by the user or other methods) to select particular Teletext pages for recording, the CPU 130 further processes the auxiliary data (steps 130(ii), 130(iii)). The further processing of auxiliary data of step 130(iii) will likely include ignoring any further processing of Teletext data or any other auxiliary data, thus stripping the auxiliary data from further consideration for recording by the CPU 130.

If the system has been programmed to select particular Teletext pages for recording in step 130(ii), then the CPU 130 separates the incoming lines for those pages from the auxiliary datastream in step 130(iv) and stores them in memory 130a in step 130(v). (As previously noted, lines are typically the basic unit of transmission of a Teletext page.) The selected data may alternatively be compressed before it is stored. The step of separating 130(iv) may include discarding the lines that make up other Teletext pages, for example, by not selecting them for storage. The separation of selected pages may be made by the CPU 130 based on the Teletext page number identified for each line in the datastream, based on the format in use and the timing of receipt, based on a combination of page number, format and timing, or based on another identification method. Any other auxiliary data may be further processed by the CPU 130 or discarded.

Thus, the Teletext data stored in step 130(v) is limited to that Teletext data selected for recording by the user, such as a certain Teletext page or pages. The data rate of lines that make up selected pages of Teletext data, of course, is much less than the data rate of lines that make up all Teletext pages. For example, the data rate of subtitle pages alone is less than 25 bytes per second. Thus, the amount of storage space in memory 130a is drastically reduced.

The datastream of lines for the selected Teletext pages may be stored in memory 130a in a number of manners. For example, where memory 130a is a hard drive or other magnetic medium, the subtitle or other select Teletext pages may be stored in a separate file that includes the lines that make up the pages. The CPU 130 generates a timestamp of the time of receipt of each of the lines that make up the Teletext pages and stores the timestamp with the lines. A timestamp is similarly associated with stored video data. Subtitle pages stored as a separate file may thus be associated with the corresponding data of a stored video program by use of the timestamps associated with the lines making up the subtitle page. For example, using the timestamp, the CPU 130 may integrate subtitle pages inside the system data packets of an MPEG stream that have corresponding timestamps (i.e., lines of a subtitle page having timestamps that are the same or closest to the timestamps of data packets of the MPEG stream are integrated), and record the compiled file in memory 130. Alternatively, the CPU 130 may insert the subtitle pages in the corresponding system data packets of an MPEG stream previously recorded in memory 130a by correlating the lines of the subtitle pages and video having the same or closest timestamps.

Although not shown in FIG. 2a, the video datastream may be related to the Teletext datastream and thus may also be separately recorded. For example, where the Teletext datastream selected for recording are subtitle pages, the corresponding video datastream is also typically recorded. Other Teletext pages may also have a video component, which may be recorded by CPU 130 in separate data files.

FIG. 2b is a flowchart depicting processing conducted by the CPU 130 of FIG. 1 in accordance with an aspect of the invention, namely, the playback of recorded Teletext data, such as that recorded as described above with respect to FIG. 2a. In step 132(i), the CPU 130 first retrieves the lines that make up the Teletext datastream for the selected page(s) stored in memory 130a. The retrieval may include a decompression of the data. The sequence of output of the stored lines may be determined, for example, by an addressing sequence used in storing the lines, or by using the timestamp to determine the sequence of lines that make up the page. The CPU 130 may perform certain preprocessing for the encoder 140. In this case, the Teletext datastream output by CPU 130 will thus generally correspond to lines that make up one or more full pages of Teletext data for a particular subject (such as soccer, weather, etc.), and will be processed by the encoder 140 so that the display format is compatible with display 200, for example, by adding appropriate control signals into the datastream at the appropriate intervals. When the reformatted Teletext datastream is output by encoder 140 to display 200, display 200 will display the full screen of selected Teletext data on the screen.

The CPU 130 will continue to retrieve and output the Teletext datastream for lines making up the pages to the encoder 140 (as represented in step 132(iv)) as time elapses over the duration recorded. Thus, the display 200 will reproduce the Teletext data pages at a time according to the timestamps associated with the lines that make up the pages, and changes thereto, over the duration recorded.

If the Teletext datastream retrieved from memory 130a in step 132(i) has a related video component, then the CPU 130 retrieves the related video datastream from memory (if recorded) in step 132(ii) and integrates the Teletext datastream with the corresponding video datastream in step 132(iii). For example, as noted above with respect to FIG. 2a, the lines that make up the subtitle Teletext datastream may be stored in a separate file or files with an associated timestamp. If so, then the integration step 132(iii) is performed, for example, by associating the pertinent lines making up a subtitle page with the corresponding video data packets in the file by correlating the timestamp of the lines of the subtitle page with the timestamp of the data packets for the video data.

After a video and Teletext datastream is integrated in step 132(iii), the integrated video and Teletext datastream is output by CPU 130 to encoder 140. (If there is no video component, the Teletext datastream alone is output by CPU 130 to encoder 140.) The CPU 130 may perform certain pre-processing for the encoder 140. The datastream output by CPU 130 is processed by the encoder 140 so that the display format is compatible with display 200, for example, by adding appropriate control signals into the datastream at the appropriate intervals. When the reformatted Teletext datastream is output by encoder 140 to display 200, display 200 will display the Teletext on the screen (along with any associated video recorded).

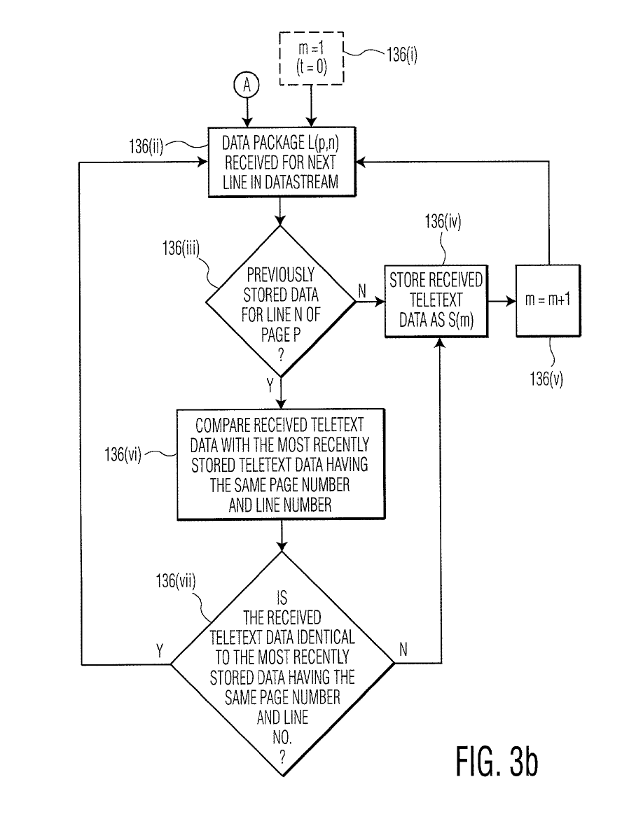

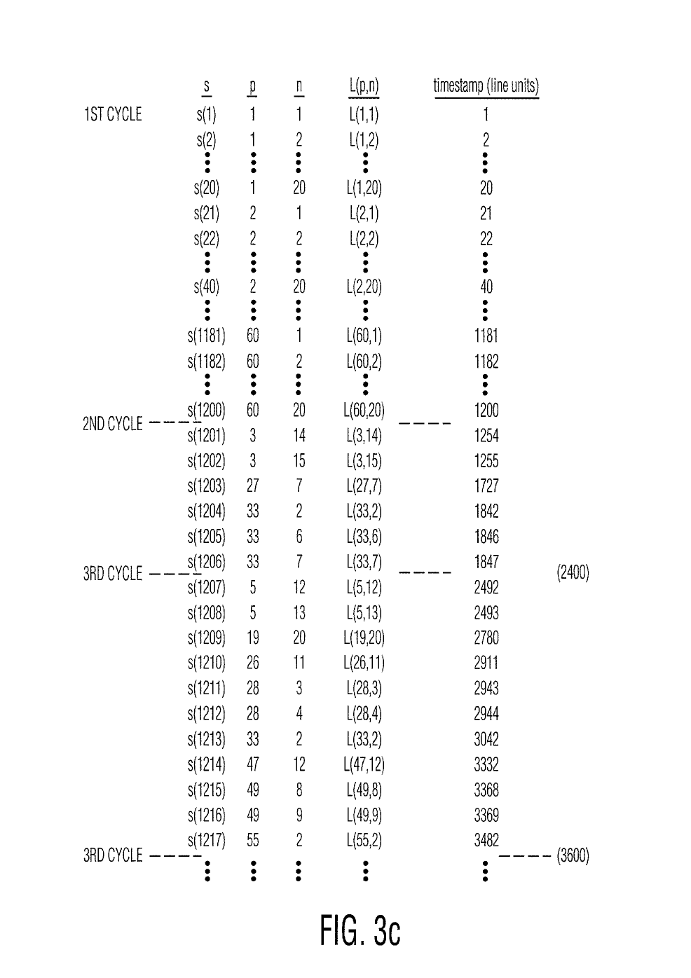

FIGS. 3a and 3b comprise a flowchart depicting processing conducted by the CPU 130 of FIG. 1 in accordance with another aspect of the invention. For convenience, Teletext alone will be focused on in the description, with the understanding that any associated video data may also be recorded by the CPU and then integrated with the Teletext datastream for playback, as described above with respect to FIGS. 1, 2a and 2b. In this embodiment, all Teletext pages in the auxiliary datastream are selected for recording. As noted above, Teletext data is broadcast in a cyclical manner, i.e., the pages are transmitted in sequence from the first page to the last page and then repeated. For simplicity, the collection of Teletext pages in the embodiment will be represented by numbers ranging from page number 1 to page number N, where N is the maximum page number. In addition, the collection of Teletext pages may also have subpages, for example “10/1” will represent page 10, subpage 1.

As also noted above, for standard formats of Teletext data, individual lines of each Teletext page are separately formatted and transmitted in the datastream. Thus, lines of a Teletext page are typically the fundamental unit of transmission. In the ensuing embodiment, the data package (or “content”) in the datastream for a line of Teletext data is represented as L(p, n), where p is the page number and n is the line number in the page.

As also noted above, some or even all of the Teletext pages may be transmitted and re-transmitted in a number of subsequent cycles without any change of the content in the Teletext pages. That is, different Teletext pages may be updated at different rates, and some or many of the update rates may slower than the time of one broadcast cycle of the Teletext data. Where the line of a page is the fundamental unit of transmission, no change of content for a page implies that none of the lines of the page have changed over the cycle or cycles of transmission.

Again, focusing on the digitized auxiliary datastream output by the A/D converter 120, the auxiliary datastream is input to CPU 130 (step 134(i)). If the system has not been programmed (by the user or other methods) to record the Teletext pages, then the CPU 130 further processes the auxiliary data (steps 134(ii), 134(iii)). The further processing of auxiliary data of step 134(iii) will include ignoring any further processing of Teletext data, thus stripping the Teletext data from further consideration for recording by the CPU 130.

If the system has been programmed to record Teletext pages in step 134(ii), then the CPU 130 separates the Teletext data from the auxiliary datastream in step 134(iv) and then transmits the resulting Teletext datastream to a comparison subroutine in the CPU 130 in step 134(v). The separation of Teletext data from the auxiliary datastream may be made by the CPU 130 based on the Teletext page number included with the lines making up the datastream, by the format in use and the timing of receipt, a combination of page number, format and timing, or other identification method. In this case, steps 134(i), 134(ii), 134(iv) and 134(v) continue to receive the auxiliary datastream from A/D converter 120 in order to supply the Teletext datastream to the comparison subroutine in FIG. 3b.

Referring to FIG. 3b, the parameter m is initialized at 1 and time t is initialized to 0 for receipt of data L(p,n) in the datastream for line n of Teletext page p, as represented by step 136(i). The “next” line in the Teletext page in the datastream for page number p is received by the subroutine in step 136(ii). Page number p can be any page number 1, 2, . . . N, where N is the largest page number in the Teletext cycle. Similarly, line number n may be 1, 2, . . . , M, where M is the last line number for page p.

The “next” line in step 136(ii) becomes the “current” line that is processed and will alternatively be referred to as the “current” line for the page. (The first line received in the datastream is also referred to as the “next” line for the Teletext page p received in step 136(ii), although it is the “initial” line received.) The CPU 130 checks the memory 130a to determine whether data has previously been stored for line n of page p in step 136(iii). If not, then the data L(p,n) is stored in memory 130a with an address referenced by parameter m, such as S(m), in step 136(iv). The parameter m is increased by one in step 136(v), and the comparison subroutine thus goes on to consider the next line of Teletext data in the datastream in step 136(ii). When the last line number n for a particular page p is reached (i.e., line M), the page number p received in the datastream will be incremented by one.

If the CPU 130 determines that data has previously been stored for line n of page p in step 136(iii), then in step 136(vi) the CPU 130 compares the received data L(p,n) for the line of the Teletext page with the most recently stored data for line n of Teletext page p. If the CPU 130 determines that the received Teletext data is identical to the most recently stored Teletext data for line n of page p in step 136(vii), then the received Teletext data in the datastream is not stored, and the comparison subroutine thus goes on to consider the next line of Teletext data in the datastream in step 136(ii).

If the CPU 130 determines in step 136(vii) that the received data for the line n of the Teletext page p is not identical to the most recently stored line n for Teletext page p, that is, the content of the line has changed for that page, then the received line of Teletext data is stored in memory with address S(m) in step 136(iv). The parameter m is increased by one in step 136(v), and the comparison subroutine thus goes on to consider the next line of Teletext data received in the datastream in step 136(ii).

Thus, a received line of a Teletext page will only be stored in memory if its content changes from the last line stored for the Teletext page having the same page number. For the first complete broadcast cycle of Teletext pages received, the decision in step 136(iii) will be “no”, since there will be no previously stored data for the lines of the pages in memory. While the first data package received in step 136(ii) may be any line of any page in the Teletext datastream, to simplify the exemplary description, it is assumed that line 1 of Teletext page 1 is received at time t=0. Thus, in step 136(iv), data content for the first line received in the datastream (e.g., data L(1,1) for line 1 of Teletext page no. 1) is stored as S(1) in memory, content for the next line in the datastream (e.g., L(1,2) for line 2 of Teletext page no. 1) is stored as S(2) in memory, etc. When the first page is completely stored, that is, L(1,M) for the last line M of page 1 is received and stored, the next data package received in step 136(ii) is L(2,1) for line 1 of page 2.

When the “next” data package (or content) in the datastream in step 136(ii) is L(N,M) for the last line M of the last page N in the cycle, L(N,M) is stored as S(Z) in memory in step 136(iv), where Z is equal to the total number of lines for all of the teletext pages in a cycle. (Thus, Z=N·M.) At this point, step 136(v) sets parameter m=Z+1 before the next line of Teletext page is considered in step 136(ii).

After N pages, the lines of the Teletext pages received in the datastream repeat with line number 1 of Teletext page number 1. Thus, after receipt of the lines for page number N, the “next” (also referred to as the “current”) Teletext page received in step 136(ii) is again line 1 of Teletext page number 1. The decision in step 136(iii) will be “yes”, since memory address S(1) contains line 1 of Teletext page number 1. The comparison subroutine compares the data package L(1,1) for current line 1 of Teletext page number 1 with the stored data S(1). If the current L(1,1) is identical to S(1), then step 136(vii) is “yes”, and the current line 1 of page 1 is not stored, thus saving memory. In that case, the next line in the datastream is considered (i.e., the second cycle L(1,2) of line 1 of page number 2) in step 136(ii).

If, on the other hand, the content L(1,1) for the current cycle is different from S(1), then step 136(vii) is “no” and the current line is stored in step 136(iv) as S(Z+1). Parameter m is incremented to Z+2 in step 136(v) and L(1,2) of the current cycle is considered in step 136(ii).

In this example, the “next” data package L(1,2) received in the datastream is line 2 of Teletext page number 1. Because S(2) stored in memory is also for line 2 of Teletext page number 1 previously received, steps 136(vi) and 136(vii) will determine whether current L(1,2) is identical to S(2). If identical, the current L(1,2) is not stored and the comparison subroutine returns directly to step 136(ii) to consider the next data package in the datastream (L(1,3)). If the content is different as determined in step 136(vii), the current L(1,2) for line 2 of page 1 is stored as P(m), m is incremented by one, and the next data package (L(1,3) in this example) is received in step 136(ii).

The comparison subroutine repeats in like manner for data for the lines of the next N Teletext pages received, thus comparing each line of each Teletext page number in the datastream in the second cycle with the same line of the page number stored in the first cycle of Teletext data received in the datastream. A line of Teletext data is stored for a page (as S(m) for the present value of m) only if it has a different content from the same line of the same Teletext page previously stored. After more than two cycles of Teletext pages have been received (2N Teletext pages, or, equivalently, 2Z Teletext lines), the current data received for the line of the Teletext page in the datastream is compared with the most recently stored data for the same line and page in step 136(vi). This may be the same line in the Teletext page for the prior cycle or one before that, depending on how quickly the content changes.

Thus, the collection of memory addresses S(1), S(2), . . . , S(Z) provide, in sequence, data for the Z lines that make up the first full cycle of N pages of Teletext data. The collection of memory addresses S(Z+1), S(Z+2) . . . provide data for received lines of Teletext pages having a changed content with respect to the same line of the same Teletext page last stored. The stored data content S(1), S(2), . . . , will generally also include the line number n and Teletext page number p that its content represents. For each line stored, the CPU 130 also stores a timestamp of time of receipt of the data by the CPU 130. As described immediately below, this allows the stored or recorded Teletext pages to be played back with the same timing as the original datastream.

The determination of whether the currently received data L(p,n) for a line n of Teletext page p is identical to the most recently stored Teletext page for the same line and page number in step 136(vii) can be performed by CPU 130 in any one of a number of ways. The data content for the current line may be compared in its entirety with the last stored line for that page by the CPU. In that case, the CPU 130 searches the memory 130a for the stored content S having the highest (most recent) timestamp and the same page number p and line number n as the current line and, once found, compares the data content. Since a line of Teletext data typically contains on the order of 50 bytes of text, two lines may readily be compared on the fly by the CPU 130.

An abbreviated comparison may alternatively be used in step 136(vii). For example, a “CHECKSUM” code may be generated and stored along with L(p,n) by the CPU 130. In general, a CHECKSUM is a binary data string that is calculated by applying an algorithm to select data of the line of the Teletext page. It is highly unlikely that the CHECKSUM for one line of Teletext data will be identical to another unless the content of the Teletext lines are identical. Thus, the CPU 130 may generate and compare a CHECKSUM for the current line with the CHECKSUM for the same line of the same Teletext page last stored. If the CHECKSUMs match, then the data content of the lines is determined to be identical in step 136(vii). If not, then the content under consideration has changed since last stored.

FIGS. 3a and 3b and the description above focused on lines of Teletext pages. As previously noted, the Teletext datastream may comprise sub-pages for particular Teletext pages. A Teletext “sub-page” number may be conceptualized as a more detailed labeling of a Teletext “page” number and may be processed in a manner equivalent to that described above.

FIG. 3c is a representative drawing of an example of lines of Teletext pages efficiently recorded for playback in accordance with descriptions given above corresponding to FIGS. 3a and 3b. Parameter L(p,n) represents the Teletext data package (content) comprising each line n of Teletext page p received. For ease of description, it is assumed that the recording begins with the first line of page 1 of Teletext data. In addition, it is assumed that there 20 lines per page and that there are 60 pages of Teletext data in a cycle, without sub-pages. Finally, the time of receipt of each line of Teletext is normalized to be a whole number multiple of the amount of time to receive one line (which is assumed to be constant). Accordingly, the time of receipt of the lines of Teletext data is designated as a “line unit of time” in FIG. 3c.

Thus, in the first cycle of Teletext pages received and recorded, the collection of lines L(p,n) begins with Teletext page number p=1, line number n=1, which in this example is the line of the first page received in the datastream when recording is initiated by CPU 130. Line L(1,1) is recorded by CPU 130 as S(1) and the timestamp associated with the S(1) is 1 line unit.

In accordance with the processing of FIG. 3b as described above, each line (n) of data L(p,n) for the first cycle of 60 pages (p) received is recorded in succession as S(1), S(2), . . . . Thus, L(1,1) is stored as S(1), L(1,2) is stored as S(2), etc. The last line (n=20) of page 1 is stored as S(20). The next twenty lines of the second page of Teletext data L(2,1) to L(2,20) is stored as S(21) to S(40), respectively. Thus, each page is stored in the next 20 increments of S. Accordingly, successive lines for pages 3 to 60 received in the first cycle are each stored in like manner over S(41) to S(1200), as shown in FIG. 3c.

Thus, S(1) to S(1200) in the collection includes the data for the 20 lines (n=1 to 20) of each of the 60 pages (p=1 to 60) received in the first cycle. S(1) to S(1200) have respective timestamps of 1 to 1200, reflecting the time of receipt of the data included in each data address S.

After the first cycle is recorded, subsequent content of lines of subsequent Teletext pages are recorded only if there is a change in content from the same line of the same Teletext page as last recorded. In FIG. 3c, S(1201) is the content (L(3,14)) of line 14 of Teletext page number 3 in the second cycle, with timestamp 1254. Thus, lines 1-20 of Teletext pages 1 and 2 received in the second cycle between times 1201 and 1240 do not differ in content from the previously recorded pages 1 and 2 in the first cycle (namely S(1) to S(20) and S(21) to S(40)) and are thus not recorded. Similarly, lines 1-13 of Teletext page number 3 received in the second cycle between times 1241 and 1253 do not differ in content from the previously recorded content for lines 1-13 in the first cycle (S(41) to S(53)) and are thus not recorded. However, line 14 of Teletext page number 3 received in the second cycle at time 1254 is different in content from the previously recorded line 14 of page 3 (namely S(54)) and is thus recorded as S(1201). In like manner, line 15 of Teletext page number 3 received in the second cycle at time 1255 is different in content from the previously recorded line 15 of page 3 (namely S(55)) and is thus recorded as S(1202).

As shown in FIG. 3c, the next recorded line of a Teletext page is line 7 of page number 27 received at time 1727. Thus, the content received of remaining lines 16-20 of page 3, lines 1-20 of each of pages 4-26 and lines 1-6 of page 27 in the second cycle do not differ in content from the corresponding lines of corresponding pages received and stored in the first cycle (as S(53) to S(526)). Line 7 of page number 27 of the second cycle differs in content from line 7 of page 27 of the first cycle (stored at S(527)). Thus, L(7,27) for line 7 of page number 27 received at time 1727 in the second cycle is stored as S(1203).

The processing continues in this manner, thus building collection S. In the example shown in FIG. 3c, lines 2, 6 and 7 of Teletext page 33 received in the second cycle are different in content from those lines for page 33 received and recorded in the first cycle (at S(642), S(646) and S(647)). The same occurs for subsequent cycles of Teletext page numbers. Each received line of a page is compared to the previously recorded content for that same line and page number to determine if the content has changed and thus needs to be recorded. For example, as shown in FIG. 3c, in the third cycle of Teletext pages 1-60 received, lines 12 and 13 of page 5 received at times 2492 and 2493 differ in content from the previously recorded lines 12 and 13 of page 5 (namely, S(92) and S(93) recorded in the first cycle. Thus, line L(5,12) and L(5,13) of the third cycle are recorded as S(1207) and S(1208). Moving ahead to S(1213), the content L(33,2) of line 2 of page 33 received in the third cycle at time 3042 differs in content from the last previously recorded line 2 of page 33 (namely S(1204) recorded in the second cycle). Thus L(33,2) received in the third cycle is recorded at S(1213).

When playing back the recorded Teletext datastream the CPU 130 re-creates the cycling or carousel of Teletext pages using the collection S and the associated timestamps. First, S(1), S(2), . . . , S(1200) are retrieved from memory in sequence, decompressed and/or otherwise pre-processed, and transmitted to the encoder 140 for processing and display over time interval 1 to 1200 in the manner previously described. As previously described, S(1) to S(20) represents lines 1-20 of Teletext page 1 in the first cycle, S(21) to S(40) represents lines 1-20 of Teletext page 2 in the first cycle, . . . , and S(1181) to S(1200) represents lines 1-20 of Teletext page 60 in the first cycle. Thus, retrieving and displaying S(1) to S(1200) creates the first cycle of Teletext pages in the playback datastream. As noted, as S(1) of the first cycle is displayed, CPU 130 initiates a clock that is correlated to the initial timestamp of S(1).

In the example of FIG. 3c, S(1), S(2), . . . S(1200), corresponding to Teletext pages 1-60 of the first cycle, are retrieved and broadcast, thus playing back the first cycle of 60 Teletext pages in the datastream. The CPU 130 clock is initialized t=0 and started as S(1) is output. The clock increments in line units, or CPU 130 otherwise correlates the clock output to line units. Thus, after S(1) to S(1200) are retrieved, processed and output to encoder 140, t=1200 line units on the CPU 130 clock.

As the clock advances past t=1200, the CPU 130 continues to use the content of the first 1200 lines S(1) to S(1200) as the basis for the playback datastream for the 60 Teletext pages, thus creating a carousel of lines of Teletext pages for playback. To maintain the proper playback timing of lines in the carousel, each time a complete cycle is played back, for example, the CPU 130 may add an offset equal to the time of one cycle (t=1200 in the example) to the timestamp of each line in the carousel. In addition, the CPU 130 continually checks the collection S and replaces individual lines of Teletext pages when a subsequent line for a Teletext page in the collection indicates via the timestamp that the time has come for a content change for that line of the Teletext page in the datastream. Thus, after creating the basis of the carousel using the first cycle of recorded Teletext data, the CPU 130 retrieves the content and timestamp for the next S in the collection (i.e., S(1201)). When the CPU clock correlates to the timestamp for S(1201), then the corresponding line for the page number in the carousel is replaced by CPU 130 with S(1201) for playback in the datastream. The CPU then retrieves the content and timestamp for the next S in the collection (i.e., S(1202)) and continues the same replacement procedure. This continues throughout the playback.

In the example of FIG. 3c, after S(1), S(2), . . . S(1200) corresponding to lines 1-20 of Teletext pages 1-60 are retrieved and broadcast, the time on the CPU clock is 1200 line units (or equivalent). S(1) to S(1200) thus make up the carousel at time 1200. The timestamps of S(1) to S(1200) in the carousel are normalized to the current CPU time by adding 1200 to the timestamp of each line in the carousel. CPU 130 retrieves S(1201), which contains the content for line 14 of Teletext page number 3, and also retrieves timestamp 1254. The CPU 130 thus uses S(1) to S(53) for the twenty lines of pages 1 and 2 and lines 1-13 of page 3 for times 1201-1253 in the playback datastream, since the content for the lines of these pages did not change in the second cycle. CPU 130 replaces S(54) in the carousel with S(1201) for line 14 of page 3 at time 1254 in the playback datastream, since the timestamp corresponding to S(1201) indicates there is a change in content from S(54) at this point in the datastream.

CPU 130 continues in a similar manner as time elapses in order to playback the recorded datastream, using the carousel to playback the datastream, while continually updating lines of pages in the carousel. Thus, CPU 130 retrieves S(1202), the content for line 15 of Teletext page number 3 and timestamp 1255. The CPU 130 replaces S(55) for line 15 of page 3 in the carousel and uses S(1202) in the playback datastream, since the timestamp for S(1202) indicates a change in content from S(55) at this point (time 1255) in the datastream. The appropriate lines of the Teletext pages continue to be replaced with the content stored in the next successive S when the associated timestamp indicates to the CPU 130 clock that it is the point in the datastream where the content of the line of Teletext page has changed.

As noted, in the example of FIG. 3c, the cycle of Teletext pages numbers sixty pages. The actual number may be greater or less, and may include sub-pages. The number of lines in a Teletext page may be greater than or less than twenty. The time of receipt of each Teletext page may differ, and the timestamp t stored with the content may be in seconds (or other unit). The actual initial timestamp given to S(1) by the CPU 130 may be other than 1, in which case all of the subsequent timestamps would have an offset equal to the initial timestamp for S(1). On playback then, CPU 130 is correlated to the initial timestamp given to S(1) as well as the time units used. Also, as noted above, in addition to storing a timestamp associated with each line content S, the line and even the page number may be stored. Thus, instead of relying on the timestamp alone to determine where a line is replaced in the carousel, the CPU may check to confirm that the correct line for a page is being replaced.

The processing described with respect to FIGS. 3a-3c above focused on the efficient recording and re-creation or playback of the datastream for all Teletext pages in the original datastream. The CPU 130 may also be programmed to select less then all of the Teletext pages from the datastream for recording, and process the one or more particular Teletext pages selected for recording in like manner. Thus, for example, if Teletext page 20 is selected for recording, for example, lines 1-20 of Teletext page 20 are recorded in the first cycle as S(1) to S(20), with timestamps 1-20 respectively. If any lines of Teletext page 20 in the second cycle have changed in content, they are selected from the datastream and recorded as S(21), S(22), etc., each with a respective timestamp. If none of the lines change in the second cycle, none are recorded. Lines of Teletext page 20 in subsequent cycles of the datastream are either recorded or skipped depending on whether the content for the line has changed from the same line previously recorded for page 20 in the collection S. The timestamps enable the processor to recreate changes in the lines of Teletext page 20 at appropriate points in the playback datastream in the manner described above.

In addition, the above-described embodiment may be readily adapted so that a page of Teletext data is the effective data package, instead of a line of a Teletext page. For the first cycle of Teletext data received, every line of every page will again be stored, as in the above-described embodiment. However, for the second and subsequent cycles, the entire page is recorded if there is any change in content in any of the lines that make up the page. For example, all of the lines of a page may be temporarily stored when received. The page may be collectively compared with the last stored page to determine if there is a change in content. Alternatively, the individual lines making up the page may be compared with the lines of the page last recorded. If there is any change in the content of the page received from the one last stored (or, equivalently, if there is a change in content of one or more of the lines that make up the page from the corresponding lines last stored comprising the page), the lines for the entire page are stored. On playback, the entire page is replaced in the carousel when there is a change in content, since all of the lines for the page have been stored when there is a change in content.

Alternatively, the CPU may re-format the Teletext data received so that the page is the fundamental unit of content, not the line. (Alternatively, the Teletext data may be formatted for broadcast, or re-formatted prior to receipt by video recorder 100, so that the fundamental unit of content is the page.) In that case, the first cycle of Teletext data received and stored by the CPU comprises a cycle of the re-formatted pages. Teletext data received in the datastream for subsequent cycles is likewise re-formatted into whole pages and its content is compared (using a CHECKSUM or other comparison) with the corresponding page last recorded to determine whether it has changed from the content of the same page last stored in the collection of stored pages. On playback, after the first cycle is broadcast and the playback carousel is created, whole pages are replaced on the carousel with subsequently stored pages based on the timestamp that is also associated with each page by the CPU.

Although illustrative embodiments of the present invention have been described herein with reference to the accompanying drawings, it is to be understood that the invention is not limited to those precise embodiments. Thus, while the above detailed description of the invention has focused on Teletext data being processed by a digital video recorder, it is to be understood that the invention is not limited to Teletext and video data or the particular video recorder and processing described above.

Thus, in general, the invention may be supported by a digital video recorder that is based upon, for example, tape, hard drive, or other magnetic media. It is equally capable of being supported by any platform that is capable of recording and/or playing back digital data, including video. For example, the invention may be supported by a PC, network or the like, in whole or in part. Thus, for example, a PC may be supplied with a digital and video datastream, such as that output by A/D converter in FIG. 1, and the processor and memory of the PC may be programmed to supply the inventive processing of the invention performed by the CPU 130. Alternatively, all of the components of system 100 of FIG. 1 may be supported by a PC or like platform, with the tuner 110, A/D converter 120 and encoder 140 being separate processing chips, or processing modules also supported by the PC processor. (The display 200 may also be the PC display.) The PC may be pre-programmed with such processing algorithms and modules, or they may be downloaded using, for example, commercial software loaded via an auxiliary drive, downloaded via a modem, for example, over the internet, or by a wireless connection.

The recording and playback aspects of the invention described above may also, for example, reside in different modules, components or even systems that are in different locations. Thus, for example, the various processing provided by the tuner 110, A/D converter 120 and CPU 130 as described above to record the digital files may be performed at one location and then transmitted to a separate location for storage and playback. For example, recording of particular data files using the invention may be performed by a commercial service, and the data files may be downloaded to a memory at the subscriber's location (via a modem, for example, the internet, or other connections, including wireless connections) for playback, or may be transmitted for playback in real time. The recording may be undertaken by the service based on subscriber input. Alternatively, the service may record all programs and supply copies to subscribers based on their selections. The subscriber's location may have the components and processing capabilities of the invention for storage and playback of the recorded files as described above or by analogous components.

In addition, while the description above focused on Teletext and video data to describe the preferred embodiments, the invention is not limited to these data types and formats. In general, the systems and processing of the invention are applicable to the recording and/or playback of related data packages that are interleaved with other related data packages and transmitted in a cyclical fashion, where the content of the data may change or not. The systems and processing may select and record particular related data packages in the cycle and discard the others. In addition, or alternatively, some of the data packages in the datastream for the particular data packages selected for recording may be skipped for recording if the data contained therein has been recorded in a previous cycle. The data may be recorded with other data, such as video or other broadcast data, as a single data structure by correlating it with a timestamp or other like timing code. Alternatively, the data may be played back with other data after storage and subsequent retrieval by correlating it with the other data using a timestamp or other like timing code.

Thus, it is intended that the scope of the invention is as defined by the scope of the appended claims.

What is claimed is:

1. A digital recording system comprising a digital processor and a memory, the digital processor selecting related data packages from an original datastream, wherein said related data packages are interleaved with other data packages in the original datastream in a repeating cycle, the digital processor storing the selected related data packages in a memory.

2. The digital recording system as in claim 1, wherein the data packages in the original datastream make up one or more Teletext pages, the processor selecting and storing related data packages for at least one of the Teletext pages included in the original datastream.

3. The digital recording system as in claim 2, wherein all of the related data packages in the original datastream making up the at least one Teletext page are selected by the CPU from the original datastream for each repeating cycle and stored by the CPU.

4. The digital recording system as in claim 3, wherein the data packages in the original datastream comprise individual lines of the Teletext pages.

5. The digital recording system as in claim 2, wherein the at least one Teletext page selected and stored by the processor is a subtitle Teletext page.

6. The digital recording system as in claim 5, wherein the subtitle Teletext pages are stored with an indicia of time received in the original datastream, the indicia of time used to correlate the subtitle Teletext pages with corresponding video data.

7. The digital recording system as in claim 2, wherein the processor selects and stores at least one related data package for the at least one Teletext page in a current cycle of the original datastream when the content of the at least one data package differs from the content of the corresponding data package last selected and stored by the processor for the same Teletext page in a prior cycle.

8. The digital recording system as in claim 7, wherein the data packages in the original datastream comprise individual lines of the Teletext pages, the processor selecting and storing a current line for the at least one Teletext page in the current cycle of the original datastream when the content of the current line differs from the content of the same line last selected and stored by the processor for the same Teletext page in the prior cycle.

9. The digital recording system as in claim 8, wherein the recorded lines for the at least one Teletext page are stored with an indicia of time received in the original datastream, the indicia of time being usable to recreate the original datastream in a playback of the at least one Teletext page.

10. The digital recording system as in claim 9, wherein the processor further creates a playback datastream of the at least one Teletext page by retrieving initially stored lines that make up the at least one Teletext page, cyclically outputting the initially stored lines in the playback datastream, and substituting subsequently stored lines for the at least one Teletext page in the cyclically output playback datastream based on the indicia of time associated with the subsequently stored lines of the Teletext page, wherein the initially stored lines correspond to an initial cycle of the original datastream and the subsequently stored lines correspond to subsequent cycles of the original datastream.

11. The digital recording system as in claim 1, wherein the system is supported by a digital video recording platform, the processor being a component of the digital video recording platform.

12. The digital recording system as in claim 11, wherein the digital video recording platform further comprises a tuner that receives an analog signal comprised of analog video signals and the original datastream comprised of the related data packages interleaved with the other related data packages in a repeating cycle, the tuner separating the data packages from the video signals and outputting an analog datastream comprising a repeating cycle of the related data packages interleaved with the other related data, and an analog to digital converter that digitizes the analog datastream output by the tuner into a digital datastream comprising a repeating cycle of the related data packages interleaved with the other related data, the datastream output of the analog to digital converter being provided to the processor.

13. The digital recording system as in claim 1, wherein the processor selects and stores related data packages in a cycle of the original datastream together with an indicia of time of receipt in the original datastream when the content of the related data packages differs from the content of the related data packages last selected and stored by the processor in a prior cycle of the original datastream.

14. The digital recording system as in claim 13, wherein the processor further creates a playback datastream of the stored related data packages by retrieving the initially stored related data packages, cyclically outputting the initially stored data packages in the playback datastream, and substituting subsequently stored related data packages in the cyclically output playback datastream based on the indicia of time stored with the subsequently stored related data packages, wherein the initially stored related data packages correspond to an initial cycle of the original datastream and the subsequently stored related data packages correspond to subsequent cycles of the original datastream.

15. The digital recording system as in claim 1, wherein the processor further creates a playback datastream of the stored related data packages by retrieving initially stored related data packages, cyclically outputting the initially stored related data packages in the playback datastream, and substituting stored related data packages in the playback datastream, wherein the initially stored related data packages correspond to an initial cycle of the original datastream and the subsequently stored related data packages corresponding to subsequent cycles in the original datastream.

16. The digital recording system as in claim 15, wherein the processor substitutes subsequently stored related data packages in the playback datastream using an indicia of time as stored with the subsequently stored related data packages.

17. The digital recording system as in claim 15, wherein the processor substitutes subsequently stored related data packages in the playback datastream using a data file structure of the subsequently stored related data packages.

18. The digital recording system as in claim 1, wherein the system comprises a service provided to subscribers, the selected related data packages stored in memory being transmitted to one or more subscribers for playback.

19. A digital playback system comprised of a digital processor and memory that creates a playback datastream comprised of related data packages by retrieving one or more initially stored related data packages, creating a carousel of data comprised of the initially stored related data packages, the carousel data being output in a repeating cycle to create the playback datastream, and substituting subsequently stored related data packages in the carousel that creates the playback datastream.

20. The digital playback system of claim 19, wherein the related data packages make up the content of at least one Teletext page stored from an original datastream comprised of data packages for a multiplicity of interleaved Teletext pages in a repeating cycle, the one or more initially stored data packages making up the content of the at least one Teletext page stored from the first cycle of the original datastream and the subsequently stored data packages making up at least a portion of the content of the at least one Teletext page stored from the later cycles of the original datastream.

21. The digital playback system of claim 20, wherein the subsequently stored related data packages are substituted in the carousel that creates the playback datastream at a time that reflects a time of receipt of the related data packages in the original datastream.

22. The digital playback system of claim 20, wherein the related data packages that make up the content of the at least one Teletext page are individual lines of the at least one Teletext page.

23. The digital playback system of claim 20, wherein the related data packages make up the entire content of the at least one Teletext page.
